(19) United States
(12) Patent Application Publication
(10) Pub. No.: US 2004/0107114 A1
(43) Pub. Date: Jun. 3, 2004

(54) System and method for processing, organizing and accessing mission critical facilities information and intellectual capital

(76) Inventor: Peter M. Curtis, Huntington, NY (US)

Correspondence Address: MORGAN & FINNEGAN, L.L.P., 345 Park Avenue, New York, NY, 10154-0053, US

(21) Appl. No.: 10/712,813

(22) Filed: Nov. 12, 2003

Related U.S. Application Data
(60) Provisional application No. 60/426,719, filed on Nov. 15, 2002.

(51) Int. Cl. G06F 17/60

(52) U.S. Cl. 705/1; 700/275

(57) ABSTRACT

The present invention relates to a system and method for processing, organizing and accessing mission critical facilities information and intellectual property. The system and method of the present invention comprises the steps of selectively gathering mission critical facilities data, providing a mechanism and procedure for inputting the information into the system, storing the data and then providing guaranteed and secure access to the information.

### CROSS REFERENCE TO RELATED APPLICATIONS

This application claims priority from U.S. Provisional Patent Application Serial No. 60/426,719, filed on Nov. 15, 2002, which is incorporated herein by reference.

### FIELD OF THE INVENTION

The present invention relates generally to the process of identifying, storing and retrieving facilities and infrastructure information. More particularly, the invention relates to providing a secure, on-demand and guaranteed access of customized and relevant mission critical facilities information in a distributed platform.

### BACKGROUND OF THE INVENTION

Many modern complexes, such as office or industrial buildings, rely on facilities such as components that are required to operate continuously (24 hours a day 7 days per week 365 days per year). Facilities within such complexes can be called mission critical facilities. In order to manage and administer the mission critical facilities, measures need to be taken to assure availability, reliability and public safety of these facilities. These goals can be achieved by improving the reliability of hardware components of the mission critical facility, such as by implementing fault tolerant architectures, introducing physical enhancements in the mission critical systems and performing (scheduled) periodic maintenance and testing of the mission critical systems and components. In addition to these hardware improvements, measures can also be taken to improve management and shared access of these mission critical facilities and systems.

Mission critical facilities management relates to the manner in which an operator or user interacts with the facility and manages the associated mission critical aspects of risk tolerance and public safety of the facility. As the size and sophistication of the mission critical facilities increases, the need for mission critical facilities management systems that (i) incorporate the critical information and (ii) provide quick and easy access to mission critical facilities data becomes more necessary. Improved facilities management can address the increased complexity and size of modern critical facilities, decrease human errors, reduce the time required to correct a faulty system or component, improve training and newly hired employee learning curve, troubleshooting and access system and emergency information.

While there are management systems available today which operate to introduce some level of management for resources in facilities, these operation management programs focus on resource allocations and general building information, and do not appropriately incorporate essential information needed to operate and manage mission critical facilities, risk tolerance and public safety. And while different types of information processing systems and methods that organize paper documentation in an electronic form are known in the art as disclosed in the U.S. Pat. Nos. 4,811,243, 4,964,060, 5,189,606, 5,526,520, 5,761,674, 5,907,850, 5,950,206 and 6,014,503 (all incorporated herein by reference), these electronic documentation and facilities data organization methods do not offer mission critical facilities management system that provides an access point to accurate, secure and customizable mission critical facilities information.

### SUMMARY AND OBJECTS OF THE INVENTION

The present invention relates to a system and method for identifying, organizing and accessing information for mission critical facilities such as, for example, office buildings, data centers, telecom centers, industrial facilities, military facilities & installations, federal and local government facilities, public buildings and stadiums manufacturing facilities and disaster recovery sites. The system and method of the present invention comprises the steps of (i) selectively identifying and gathering mission critical facilities information, such as data, (ii) providing a mechanism and procedure for inputting the information into a system, (iii) storing the information and then (iv) providing guaranteed and secure access to the information.

Selectively gathering mission critical facilities information can be done by determining the mission critical data for a given facility. Inputting the determined data directly into the system can be done using templates or data entry toolkits, and the like. Storing the information into a system can be done by organizing the data in a plurality of datastores (e.g. databases), determining Standard Operating Procedure (SOP), Emergency Action Procedures (EAP) and Alarm Response Procedures (ARP) for a given facility, embedding mission critical compliance indicators and engineering operations to produce improved system availability and public safety, augmenting facility data with education information, Original Equipment Manufacturer (OEM) information and other non-facility specific information, providing secure access to system data (e.g. encryption, biometrics, eye scan) for both entering and retrieving data, and gathering and populating data templates and storing data in appropriate locations within the database. Providing guaranteed and secure access to the mission critical facilities can be done by presenting information to users via desired formats, e.g. web pages, network terminals, electronic media or print reports. Search engines, authentication techniques and audit trail software to provide a user-friendly interface can also be utilized.

Other objects and features of the present invention will become apparent from the following detailed description in connection with the accompanying drawings. It should be understood, however, that the drawings are presented for the purpose of illustration and not as a definition of the limits of the invention.

### BRIEF DESCRIPTION OF THE DRAWINGS

FIG. 1 is an illustrative embodiment of the high level overview of the system.

FIG. 2 is a schematic layout of the system as it connects to the Internet.

FIG. 3 is a flow chart showing the process for identifying and gathering the mission critical facilities information.

FIG. 4 is a schematic block diagram of the system showing the interface for gathering and displaying the mission critical facilities information.

FIG. 5 is a schematic layout for organizing mission critical facilities information.

FIG. 6 is a diagram of at least one table in the database.

FIG. 7 is a flow chart of the process for building the mission critical facilities presentation.

FIG. 8 is a schematic block diagram of the layout and organization of web pages forming an overall template for presentation of the mission critical facilities information.

FIG. 9 is a schematic drawing showing an access hierarchy for system users.

FIG. 10 is a flow chart of the process for logging into the system.

### DETAILED DESCRIPTION

Complexes, such as buildings, rely upon mission critical facilities information.

The particulars of mission critical facility information depend on the complex industry or work environment under consideration. Typical complexes include, office buildings, data centers, telecom centers, industrial facilities military facilities & installations, federal and local government facilities, public buildings and stadiums, manufacturing facilities, disaster recovery sites, and so on. The mission critical systems housed in these facilities can be power generation systems, such as generators, uninterruptible power supplies (UPS), DC rectifiers, battery systems, electrical systems, security systems, heating and ventilating systems (HVAC), fire detection systems, fire protection systems such as standpipes and sprinkler systems, fire suppression systems, and so on. Generally, mission critical facilities can be any type of system necessary to keep operations and safety systems running in an uninterruptible and continuous manner.

The systems and methods of the present invention utilize a computer network, which in one embodiment can include one or more servers for organizing and accessing mission critical facilities information. The systems and methods incorporate at least one database that can comprise a plurality of tables listing and organizing information relating to mission critical facilities.

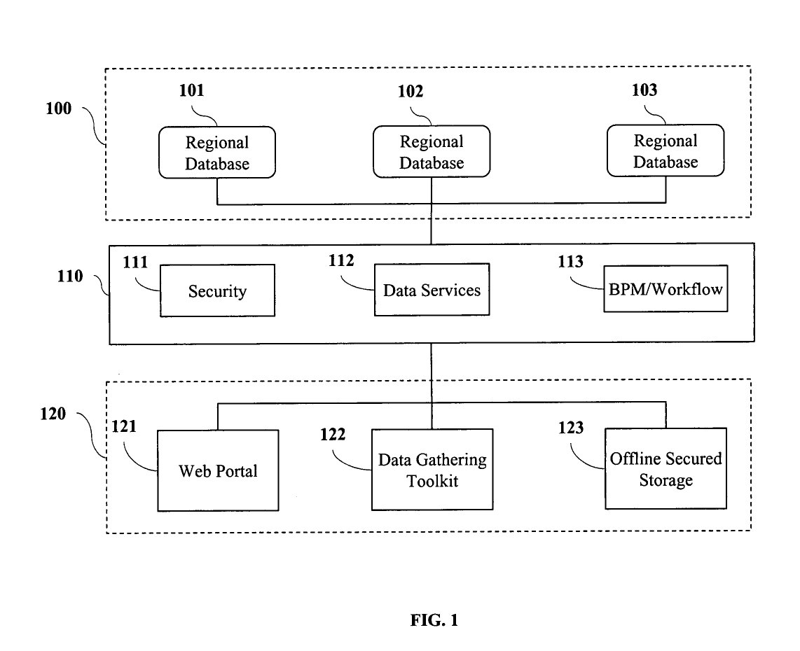

The main entities of the systems and methods of the present invention can be categorized as three logical entities 100, 110 and 120, as shown in FIG. 1. It is to be understood that while the three entities are shown as separate logical units in FIG. 1, in different embodiments the entities may be combined. The first entity 100 in FIG. 1 represents information databases, which identify and store mission critical facilities and other supporting information. The second entity 110 is the access control software, which controls the overall organization of the information delivery and access security. The third entity 120 is the user interface, which can include a web portal, a data gathering toolkit and an off-line storage device.

In one embodiment of the present invention, a plurality of datastores (e.g. 101, 102 and 103) are utilized in order to provide storage redundancy and geographic diversification for the mission critical facilities information. The datastore can be on-line or off-line, which can be stored in the form of a structured database or presented in a single file format protected by encryption techniques. The terms database and datastore are used herein interchangeably.

The data can be stored in any standard database structure, such as an ANSII-92 compliant database. The data can be replicated via internal processes to multiple instances of the underlying databases that can be placed in disparate geographic regions, as in databases 101, 102 and 103. Fault tolerance can be obtained by providing the geographically disparate implementations of the data service component such that the standby implementations are activated in the event that a regional data center is lost.

User access to the regional databases 101, 102 and 103 can be controlled by access control software 110, which can comprise security verification software 111, general data services software 112 and Business Process Management (BPM) and Workflow software 113. The access control software 110 collectively insures proper routing of secure user information for approval process and can determine if the user is authorized to view or input information into the system. In one embodiment, Application Programming Interface (API) can be used to integrate third party software application with the software access control 110.

The security verification software 111 can insure proper authorization and authentication and provide access and rights management in the system. Integration with other third party security and rights management software using an API can also be provided.

The Business Process Management and Workflow software 113 provides approval and change management control of system contents and data. It is responsible for allowing users to access and input information into the database based on a previously determined authorization level of the user.

The user interface 120 includes a web portal 121, which provides the primary user interface to the system. The user interface 120 allows authorized users to view database contents, including current and historical information and annotations. It also provides access to training, manufacturer support information, and management information. Software that monitors access to the system and provides audit trail of users sessions can also be provided.

The user interface layer further comprises data gathering toolkits 122 which can include templates for collecting mission critical facilities information and to insure the relevance of that information. The system includes an offline secured storage device 123 (e.g. backup CD ROM or flash memory device, smart device, or any other data storage device). The offline secured storage device 123 provides access to data stored in the web portal when the connection to the system on-line databases is not available. Access to the offline can be limited in duration and can require an additional level of security. Accordingly, off-line data can be cleared from the portal after a specified number of invalid access attempts or after termination of a user-specified time span. Printed versions of this information can be made available from the data stored in the offline secure storage device 123.

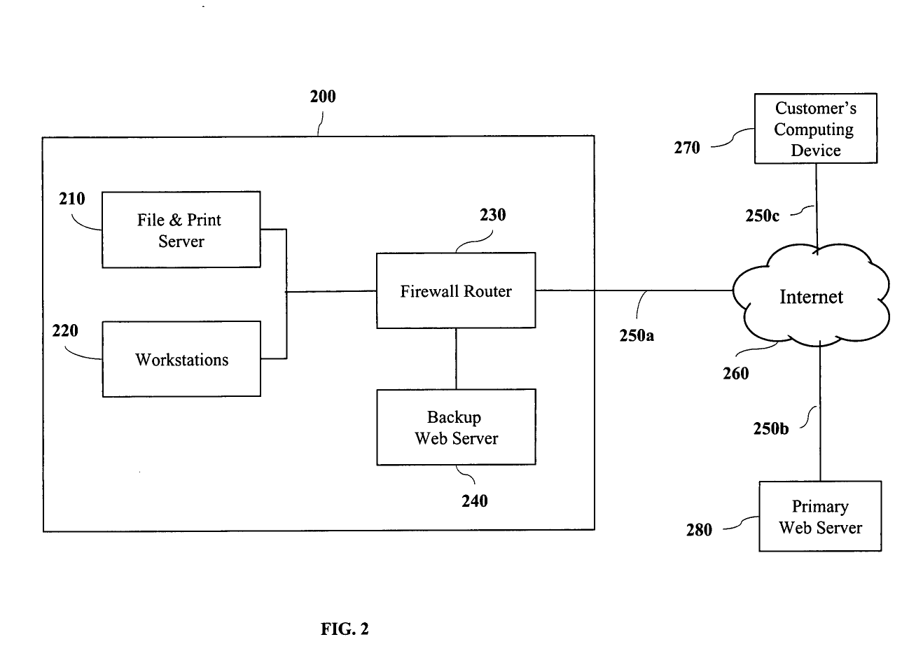

In order to enable connectivity between the various geographically disparate databases and allow authorized users to access the mission critical facilities information from any location having Internet access, Internet connections can be used to facilitate communication between the various entities described in FIG. 1. FIG. 2 shows a schematic layout of the system as it connects to the Internet.

In the system embodiment shown in FIG. 2, several web servers are connected in a network. Each web server comprises a database, access control software and user interface modules. The illustrative embodiment shows a network having three servers 210, 240 and 280. Servers 210 and 240 are located within the same entity 200 responsible for collecting and managing the mission critical facilities information. As seen in FIG. 2, one or more workstations 220 can connect to remote server 210 through a secure Intranet connection. Server 210 and workstations 220 are also in communication with a firewall router 230 which is also in communication with a backup web server 240. Firewall router 230 keeps server 210 secure from unauthorized intrusions.

Backup web server 240 assists in the display of information if a primary web server is down. Firewall 230 connects to the Internet 260 via one or more Internet connections 250a. There is also a primary web server 280 in communication with Internet 260 via an Internet connection 250b, and a customer's computing device 270 in communication with the Internet 260 via another Internet connection 250c. According to this embodiment, there can be one or more customer computing devices gaining access to mission critical information at the primary web server 280. In order to keep the information secure and protected on the primary web server 280, this information is protected through a secure connection and can be accessed only by inputting a valid username and password, fingerprint, optical scan, secured card or other future secure smart devices. In addition, the server 210 which provides this mission critical information to primary web server 280, can continuously update information on primary web server 280 through firewall 230.

In managing mission critical facilities, selective gathering of the relevant critical information is very important. The present invention provides templates and toolkits that selectively collect the mission critical information and further displays this information prominently to the users. Further, the present invention provides tools, templates and embedded mission critical compliance indicators for automatically and efficiently capturing facilities information and assembling the essential information into a single comprehensive electronic document.

The selected mission critical facilities information is converted into electronic form and then integrated into the system database. System databases include any SQL-92 compliance storage systems, flat text files, object storage systems and the like.

Mission critical facilities information is the level of information needed to manage complexes and associated risk and public safety. Examples of mission critical information include, but are not limited to infrastructure information, engineering drawings, digital photos of critical systems, nameplate data, warranty information, digital photos, cut sheets, CAD drawings and emergency contact information.

The data gathering step is flexible and can accept various formats, including but not limited to paper copies, electronic documents, blue prints and engineering drawings. Annotations of digital photos, graphics, multimedia, and charts can also be added.

The data collection templates and toolkits can be tailored to various types of facilities in order to accommodate the different architectures and configurations of the mission critical facility in these different complexes. The data gathering toolkit can provide tools and application specifically tailored for specific operating environments, such as telecommunication centers, military facilities & installations, public buildings and stadiums or power plants. Application for online and offline data input that automatically accepts data from bar code scanners, paper scanners, printers or digital cameras can also be included. When electronic data is entered automatically to the system, virus scanning software can be used to exclude infected data prior to committing the data to the database.

After selectively collecting the mission critical facilities information, the collected data can be augmented by customer intellectual property or intellectual capital, i.e., detailed descriptions of facilities, standard operating procedures, emergency action procedures, alarm response procedures, troubleshooting guides and schematics. Added non-facility specific information can be tailored for the specific work environment of the mission critical facility.

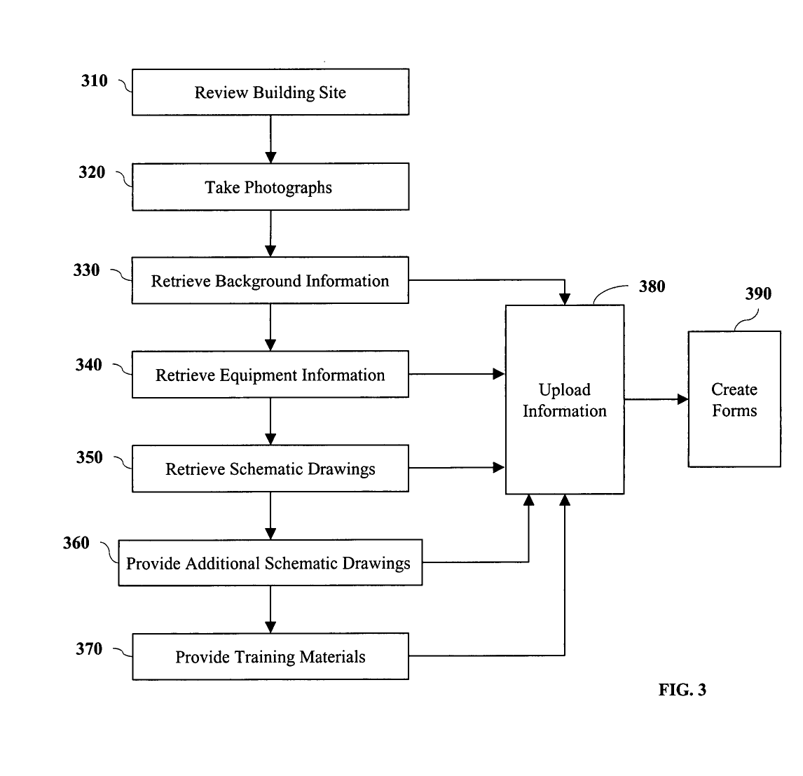

FIG. 3 is an illustrative example of one embodiment for gathering mission critical facilities information. In step 310, a user reviews a building site by either visiting the site or calling a building owner to discuss the background of the building. Next, in step 320, the user obtains photographs of the building wherein these photographs can include outdoor and indoor photographs of a building, photographs of power generation systems, security panels, sprinkler control panels, telecommunication systems, power distribution systems, heating, cooling, ventilating systems and other building infrastructure and mission critical intellectual property. In step 330, a user collects building specific information, including contact information, utility power information, building square footage, year built, HVAC information, general maintenance information, standby generator power information, and water supply information. The information can include historical information, i.e., prior versions, should that information be deemed necessary.

The gathered information is then uploaded into the system database in step 380 and the appropriate data tables and forms are created based on the inputted information in step 390. The system and method can be equipped to require the input of certain minimum or basic information.

If a user wanted to create a more detailed set of information, in step 340 equipment information can be collected relating to machines or other devices used to operate mission critical devices. For example, detailed information relating to the make and model of the HVAC systems, standby power generators, battery backup systems (UPS), security systems, sprinkler systems, fire alarm systems, electrical systems or any other machinery or electronic devices required to perform mission critical operations can be included.

Next, in step 350 the user can collect schematic drawings relating to the layout of the building. These schematic drawings can include blueprints of floor plans, electrical systems layouts, sprinkler systems layouts, public safety layouts and security systems layouts. If the facilities manager does not have this information, then in step 360 the user can create or update these schematic diagrams for inputting into the server. Here again, historical information can be kept for access.

Next, in step 370 the user either obtains or provides any additional training materials which can be used to aid the facilities manager in informing users of how to use one or more of the mission critical operations associated with a building.

In step 380 this information is uploaded into the server wherein this information is then allocated into the different system databases. However, the gathered information may be uploaded after each step (e.g. 340, 350, 360 and 370). In another embodiment of the present invention, the sequence can be interchanged, e.g. steps 330 to 370 can be interchanged.

The present invention allows mission critical information database to be updated and reviewed without having to overhaul the entire database and bring the system down every time an update is needed. Multiple users can participate in the viewing and updating the database contents at the same time.

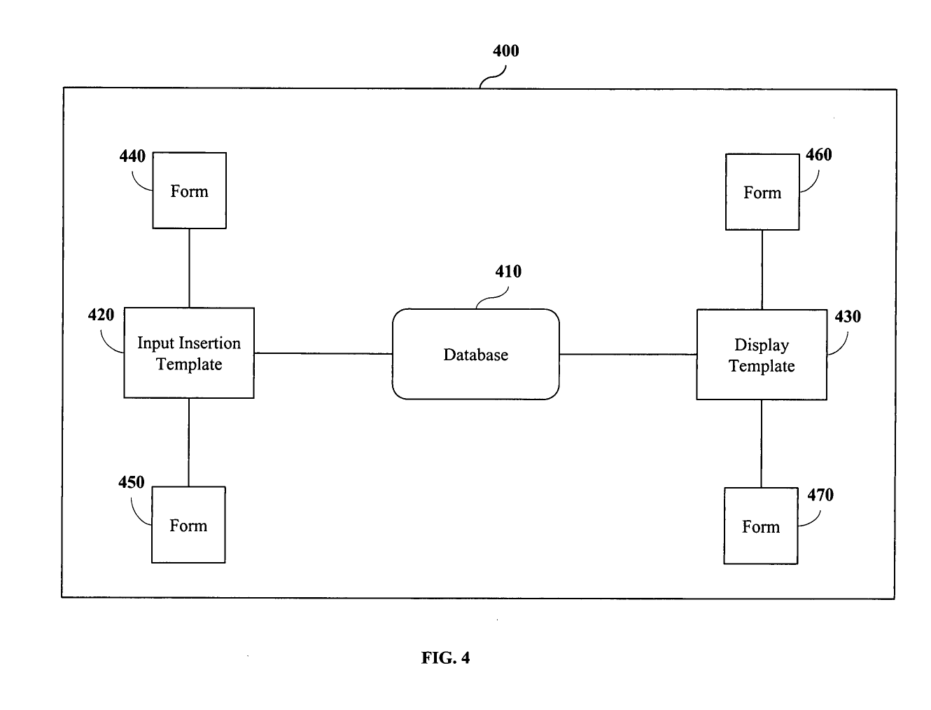

Thus, FIG. 4 is a schematic block diagram showing the input/output process in relation to the system database 400. The system can be set up to gather mission critical information and then facilitate access to this information. Thus, there is shown a database 410 that is in communication with an insertion template 420 for inserting mission critical information and also in communication with a display template 430 for displaying this mission critical information. The insertion template can comprise of one or more forms (440 and 450). In one embodiment, forms 440 and 450 present a series of questions to the user to insure that sufficient mission critical facilities information is gathered. The forms can be either active or passive. If the forms are active then insertion template 420 presents different questions in response to a previous answer by a user. This system and process allows mission critical information to be accessible to one or more users through a standard web browser such that this information can be efficiently compiled and distributed via the insertion template 420 and the display template 430. While other formats are possible, in one embodiment, the information is presented via the web browser format, as shown in forms 460 and 470.

Other systems and methods can be used to gather and present mission critical information. For example, rather than using the insertion template 420 shown in FIG. 4, in another embodiment the data is gathered and incorporated into the system without a template. The invention allows users to scan papers, pictures, drawings and graphical data via one or more of the commercially available tools wherein this information is stored electronically in a computer GIF file. Paper based word or type written documents are scanned in and stored in an electronic format using commercially available conversion software. The electronic engineering drawings may be converted to a DWF file format using computer aided design (CAD) software wherein this information is stored in the server. All digital video images can be stored in MPEG format while the viewing of this information is integrated via HTML programming language used to design and link different display pages for a website.

In 430, the general layout can include the following sections of a web page: a left menu having a list of categories having links to respective category areas, a top menu having a navigation bar, a customer's logo, an email link to the web sites administrator, and a display area primarily used to display the content files used to provide links to content files. This initial display will allow users to view the display template and provide tools for adding or editing the display pages.

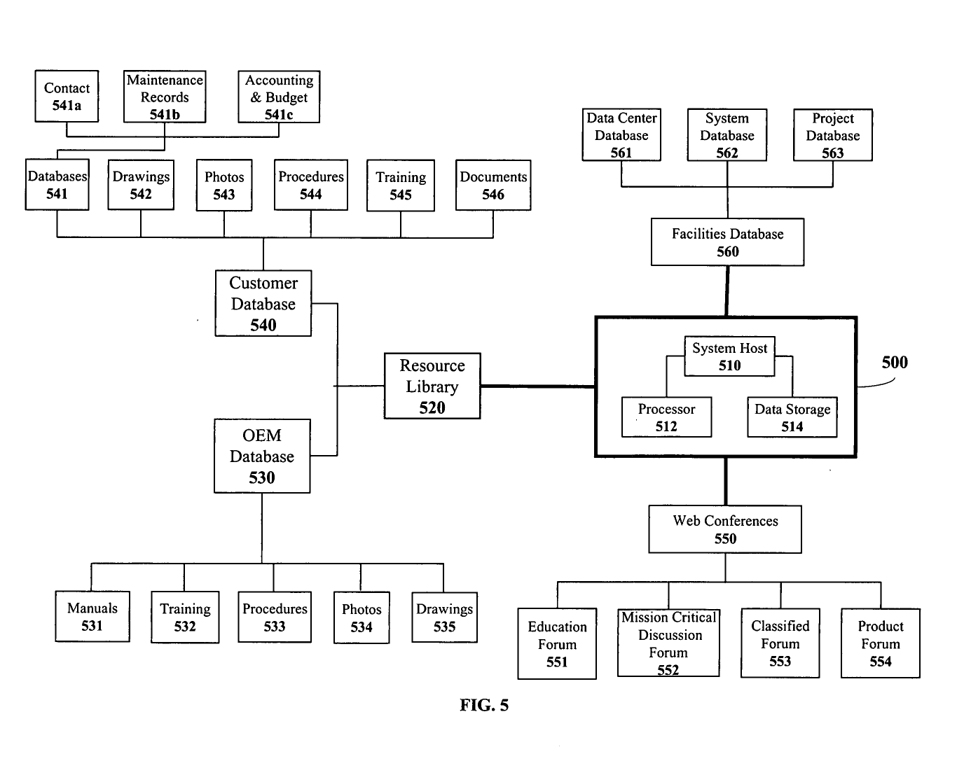

The data gathered in the initial step is stored in one or more databases. FIG. 5 is a schematic layout of a system for organizing mission critical information. The system includes a server 500 which has a processor 512, a data storage device 514, wherein a system host 510 or access control software is at least partially stored in storage device 514, and runs on processor 512.

In FIG. 5, there are three main categories of information stored in the database. First, data is stored in a resource library 520, which comprises Original Equipment Manufacturer (OEM) data 530 and customer data 540. The OEM database 530 further comprises information provided by the developer or manufacturer about products which can include user manuals 531, a training manual library 532, procedures library 533, a photos library 534 and a drawings library 535 (includes blueprints or other schematic drawings of a building). The corresponding customer database 540 can include information provided or developed by the customer, agents or end users. The customer database 540 can include databases 541 (which can include contact information 541a, maintenance records 541b and accounting and budget information 541c), a drawings library 542, a photos library 543, a procedures library 544, a training manual library 545 and a documents library 546.

Server 500 also provides a web conference forum 550, which can comprise an education forum 551, a mission critical discussion forum 552, a classified forum 554 and a product forum 552. These forums allow different users to communicate among themselves to share information about mission critical operations of a building with the goal of increased uptime, reliability and public safety.

A third service provided by server 500 is a facility database 560, which includes a data center database 561, a system database 562, and a project database 563.

Those skilled in the art will appreciate that the various databases sections represent logical components of the database and not separate physical entities. The logical data structure may change in other embodiments to include data relevant for different facilities environments.

After gathering and inputting mission critical facilities information into the system and method, information can be further augmented by adding corresponding information for standard operating procedures (SOP), emergency action procedures (EAP) and troubleshooting guides. In addition, OEM manuals, education and training materials, schematic drawings and other non-facility specific information can be presented and linked to the mission critical facility data. Thus, the present invention can provide the ability to create and supplement external SOP, EAP, education, help and troubleshooting guides.

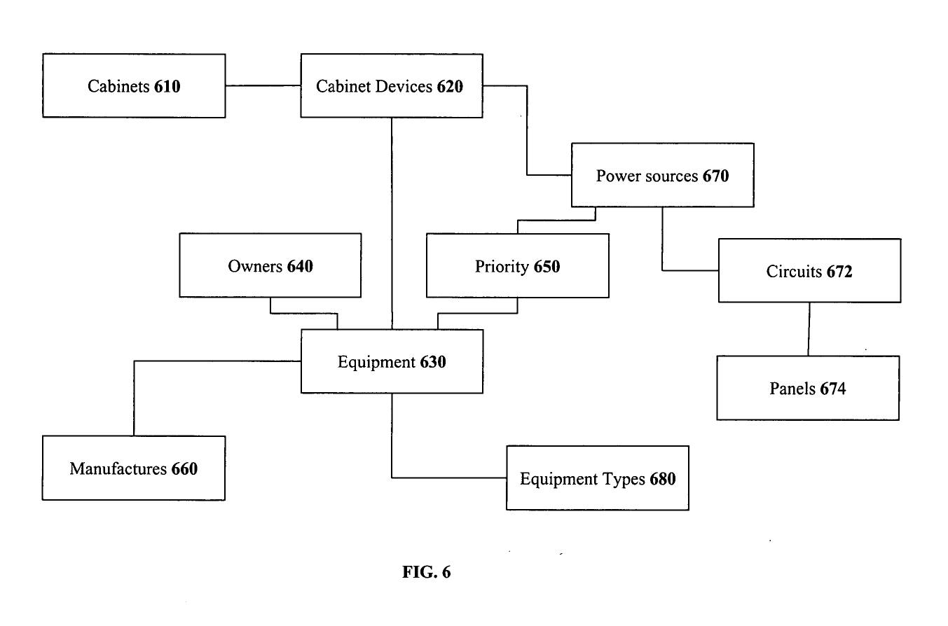

Mission critical facilities information in the database can be organized in tables such that the relevant system information (including SOP, SAP, troubleshooting guides) can be quickly linked together. FIG. 6 is an illustrative example of a database table structure for mission critical facility that houses information technology (IT) equipment. The table is stored in a database in a data center. The database is used to track and record information relating to data centers such as those used in the information technology field. This table structure can include other specialized sub-tables containing information about cabinets 610, cabinet devices 620, ownership information 640, power sources 670, types of circuits 672, listing of panels 674, priority information 674, listing of equipment 630, equipment types 680, and listing of original manufacturers 660.

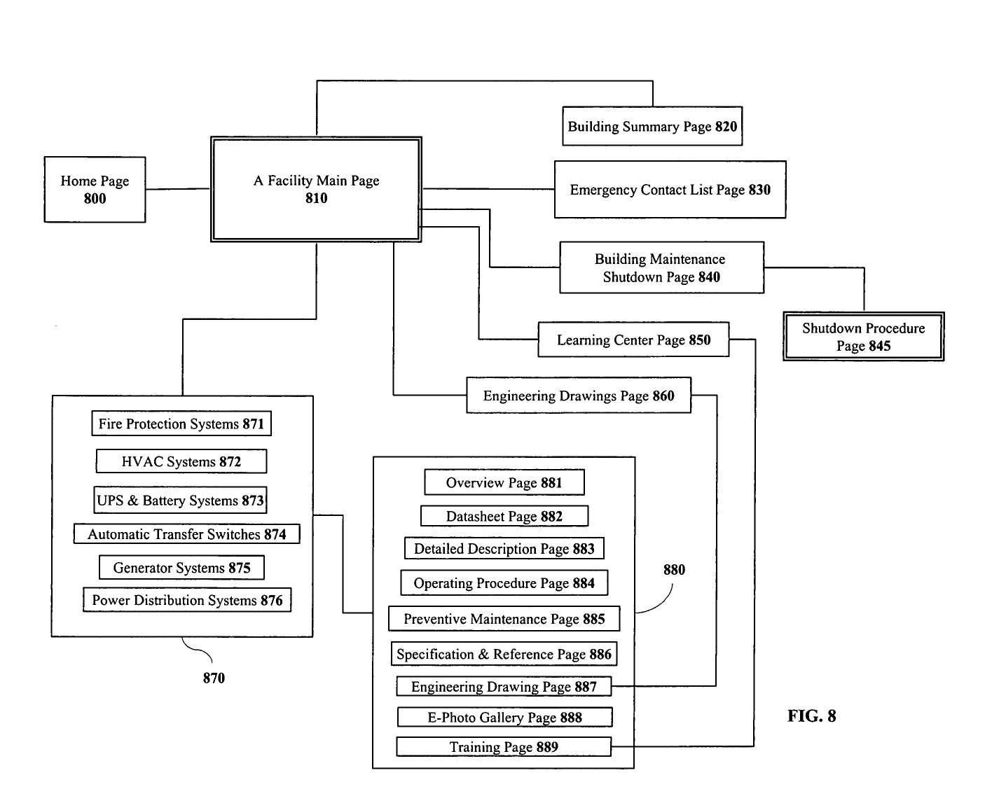

The linking of the various sub-tables can be designed such that the mission critical facilities information is accessed very quickly and in a simplified manner. The sub-tables links shown in FIG. 8 represent one possible embodiment. Numerous other embodiments are possible.

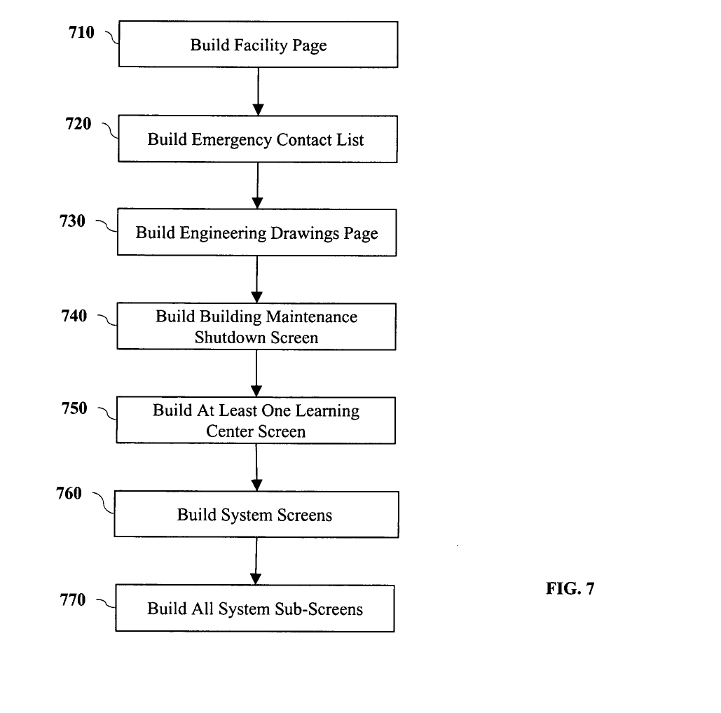

FIG. 7 shows one possible embodiment for generating the presentation screens based on the information stored in these tables. In step 710, the system host instructs the access control software to create the facility main page, introduction screens, facility specific pages. These pages are placed into an ordered template to form the final mission critical facility web pages.

Next, in step 720, a web page showing an emergency contact list is generated by pulling information relating to contacts (e.g. database information 541a in FIG. 5). This contact information is then placed into a preset template. Next, in step 730 a web page showing engineering drawings for the building is generated and presented in another web page. The engineering drawing web page can include, for example, a sample riser diagram, a sample floor plan, and a fuel system process diagram.

Next, in step 740 a building maintenance shutdown screen is generated. The building maintenance shutdown screen relates to the EAP and includes a list of activities necessary to shut down the operation of the building, sequence of operator-performed steps and the person(s) responsible for performing these steps. Next, in step 750 at least one learning center screen is generated wherein this learning center screen includes a course outline and table of contents for current or future classes that relate to the managed mission critical facilities.

In step 760 the system generates the various detailed system screens. These system screens can be for power generation systems such as generators, electrical systems, security systems, heating and ventilating systems (HVAC), fire detection systems, fire protection systems such as standpipes, sprinkler systems, and fire suppression systems, and any other type system necessary to keep business operations and safety systems running on an uninterruptible and continuous basis. Each one of the system sections can include one or more pages representing the customized or generic information for system overview, datasheets, a detailed description of the system, operating procedures, preventive maintenance, specifications references, engineering drawings, an e-photo gallery, training, and so on.

Immediate links to the various systems (i.e., without hierarchical navigation) can be obtained by selecting the appropriate key words and system sub-menus. Thus, once at least one of the main system pages is generated, then each of the sub-screens for the main system screen can be generated in, e.g., step 770.

The design of the web screens can be standardized to create a common platform for all mission critical facilities. Other times, the design can be customized. FIG. 8 is an example of a schematic layout of an underlying web screens. There is shown a home page 800 which links to one or more facility pages 810. These one or more facility pages 810 further link to a building summary page 820, an emergency contact page 830, a building maintenance shutdown page 840, a learning center page 850, and an engineering drawings page 860. The building maintenance shutdown page 840 also links to one or more shutdown procedures pages 845. The facility page 810 also links to one or more systems pages 870 which can include fire protection systems 871, HVAC systems 872, UPS and Battery systems 873, automatic transfer switches 874, Generator systems 875, and power distribution systems 876. Each one of these system pages can link to one or more subsystem pages 880.

The subsystem pages 880 can include a system overview page 881, a datasheet page 882, a detailed description page 883, an operating procedures page 884, a preventive maintenance page 885, a specification and references page 886, an engineering drawings page 887, an e-photo gallery 888, and a training page 889. According to this embodiment, the engineering drawings area 860 and the learning center area 850 are linked to the engineering drawings page 887 and the training page 889, respectively. Once all of these pages are generated, users may create one or more different media presentation, such as a web page.

The illustrative embodiment of FIG. 8 represents one possible scheme for linking various web pages and the underlying data. The invention does not preclude the design of other methods for linking these or other web pages.

Considering the sensitivity of mission critical facilities information, the present invention incorporates several mechanisms to insure secure access to the mission critical facilities data and to provide the proper authenticating for users. In one embodiment of the present invention, all data transmissions are encrypted. Since this information can only be accessed through a secure connection or secure socket layer (SSL) this information can be protected and secured against unwanted access by non-authorized users. Furthermore, the offline data storage is protected with data encryption and removal techniques that uses a dynamic pki encryption algorithm which causes the data to self destructs when the proper authorization is not entered. The present invention facilitates the integration of SecureID, biometric, and other current or future secondary or device-based security using the API.

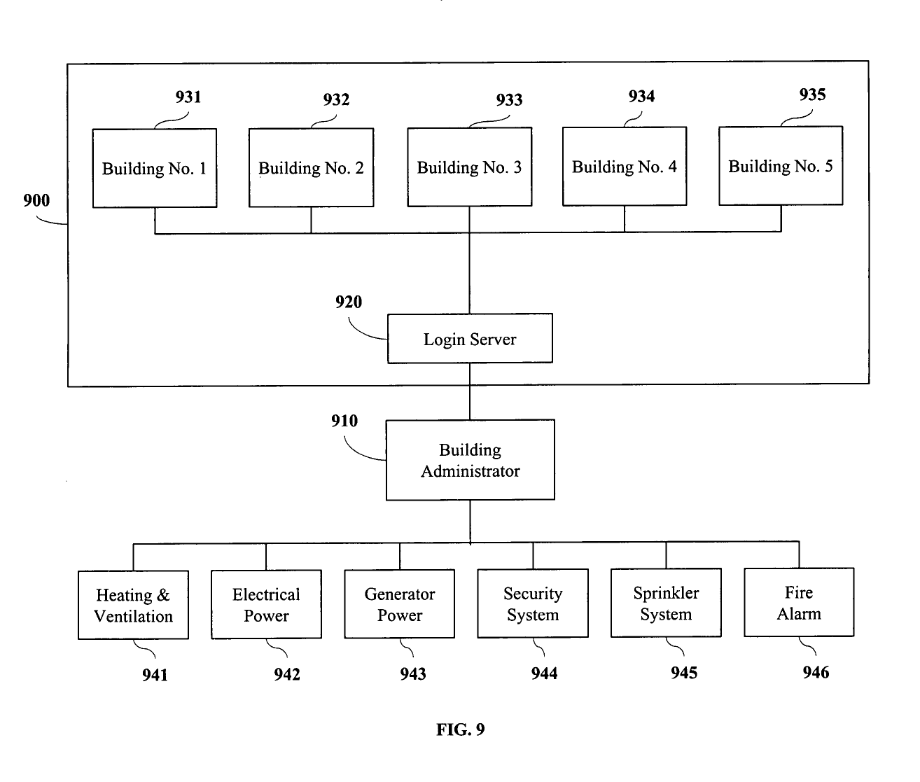

Authorized users can access mission critical facilities information on-demand, either locally or remotely, in a guaranteed manner. FIG. 9 is a schematic drawing showing an access hierarchy for users of the system. According to FIG. 9, mission critical facilities manager (building administrator 910) controls access to information stored on server 900. The building administrator 910 further administers and determines authorization for all other users based on locational and functional responsibilities. For example, the building administrator can prearrange the following six mission critical work categories for employees: HVAC 941, electrical power 942, Generator Power 943, security systems 944, sprinkler systems 945 and fire alarms 946. The building administrator 910 has the ability to edit, add or delete these categories if desired. Furthermore, in facilities spanning multiple buildings, the responsibility of each authorized user can be determined, e.g., assigning authorized users for buildings 931-935. Thus, while the building administrator can access all of the information relating to the entire facility, individual building administrators have restricted access to only the information in their work category. Each building administrator will be verified and given the appropriate authorization after login into the login server 920.

When two users log into server, the two users are able to communicate with each other about information stored on the server. However, both of these users would be restricted from sharing information outside of their access level.

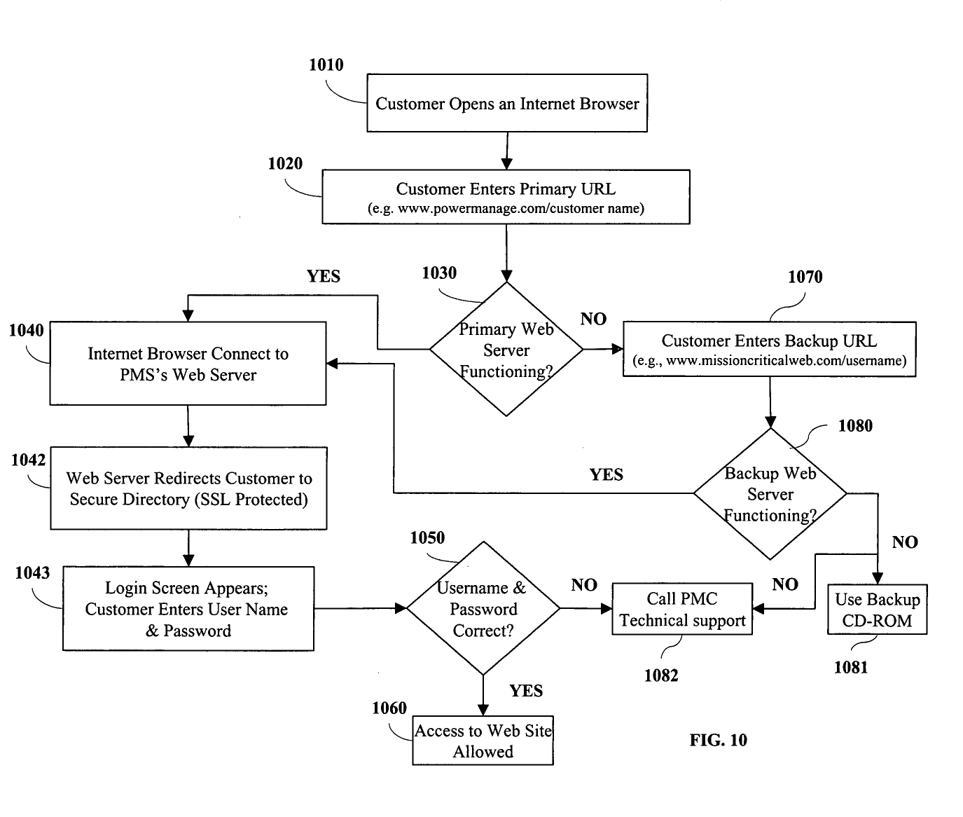

FIG. 10 is a flow diagram of the process for logging into the system. This system allows a user to have access to mission critical facilities information by one of three ways, primary server, backup server or through an off-line secure storage device containing the mission critical systems information relating to the complex. First, in step 1010, a customer opens an Internet browser using a personal computer or any other computing device. Next, in step 1020 a customer enters the primary URL address to log into the primary web server. If the primary web server is not functioning at 1030, then the user enters the backup URL address in step 1070 to gain access to backup web server. If either the primary web server at 1030 or the backup web server at 1080 is functioning, then the customer's Internet browser is connected to the system in step 1040.

Once the Internet is connected to the system in step 1040, the web server redirects the user to a secure directory that is SSL protected in step 1042. Next, in step 1043 a login screen appears and a customer enters a username and password. Finally, once the username and password are accepted at 1050, the customer gains access to the web server and the authorized sections of the data, as indicated in step 1060. Otherwise, the customer is directed to a technical support center in step 1082.

On the other hand, if both primary server at 1030 and secondary server at 1080 are not functioning, the user is directed to the off-line secure storage (i.e. backup CD-ROM) server in step 1081. If access to the secure storage device is not authorized or the secure storage device is not available, the customer is then directed to a technical support center at 1082.

If after repeated attempts (e.g. 3 tries) the user cannot log in to any of the server, then the user is directed to a technical support center in step 1082.

Since quick and accurate access to the relevant information is a critical component of mission critical facilities management, the present invention provides guaranteed secure access to data in various delivery methods, including the web and off-line encrypted data sources. System users have the ability to customize mission critical facilities information display. Users can search the databases for specific information by index or search commands.

The present invention allows users to access mission critical facilities information via the customer own web server, the managing entity web server, customer file and print server or backup CD-ROM. The managing entity web server refers to the web site of entity responsible for collecting the information and managing the overall system. Customer information is kept updated at the server by transferring all customer files to a primary web server and to a local backup web server. If the primary web server is not responding, the customer can use an alternate URL and connect to the backup web server.

According to one embodiment of the present invention, the web portal is the primary user interface. It allows the viewing of current and historical information and annotations. It also provides access to training, manufacturer support information, and management information. All data access is monitored and restricted according the level of authorization for the users.

In another embodiment, the present invention utilizes the Internet and browser technology to present mission critical facilities information and education materials in a format and a medium that is consistent and familiar to users. The use of standard software application in the present invention allows users to access mission critical facility information using personal computers, laptop, handheld PDA devices, CDs, or flash memory, or other future device readers without the need for special software. It also provides immediate access to critical information and the underlying supporting information quickly, without presenting irrelevant distracting information.

For added security and ease of troubleshooting, the present invention allows administrative users to retrieve and review the history of access to the system, the commands used, software versions, corresponding versions of database (e.g. old versions of data wiring, old equipment). This allows managers and administrators to trace system history and correlate specific users with facility view, printout and data entry.

A revision template is embedded into the software to provide the customer and administrator full audit history of users' accessing and entering/modifying information and documents into the system. A notification system is also included into the software which can notify (e.g. e-mail, page, fax) the administrator when changes or revisions to the document occur.

The database linkage to training and OEM information can be accessed via hot links from the customer various facilities web pages, or using search commands. In one embodiment, the invention allows users to ask questions or search topics using a wildcard search.

Accordingly, while at least one embodiment of the present invention has been shown and described, it is to be understood that many changes and modifications may be made thereunto without departing from the spirit and scope of the invention as defined in the appended claims. Thus, while the description of the present invention focused on mission critical facilities information in industrial or commercial facilities, the invention can be used in other applications. For example, homeowners may utilize the invention to access the mission critical information for a home (e.g. furnace, security system). The homeowner can get access to information including user manuals, manufactures information, trouble shooting guides and replacements parts.

Without departing from the spirit and scope of the invention. It is therefore intended that the present invention is not limited to the disclosed embodiments but should be defined in accordance with the claims, which follow.

We claim:

1. A method for identifying, processing, organizing and, accessing mission critical facilities information and mission critical intellectual property, comprising the steps of:
a) selectively identifying and gathering the mission critical facilities information;
b) inputting the information into a computer system;
c) storing the information in a database; and
d) providing authorized users guaranteed access to the mission critical facilities information.

2. The method of claim 1 further comprising the step of converting the mission critical facilities information into an electronic format after selectively gathering the information.

3. The method of claim 1 wherein the step of inputting the information into the computer system uses a pre-defined templates.

4. The method of claim 1 wherein the step of inputting the information into the computer system uses data entry toolkits.

5. The method of claim 1 wherein the step of inputting the information into the computer system comprises inputting the information directly in electronic form.

6. The method of claim 1 wherein the step of storing the information in the database further comprises organizing the information in tables.

7. The method of claim 1 further comprising the step of determining and inputting standard operating procedures for the facilities.

8. The method of claim 1 further comprising the step of determining and inputting emergency action procedures for the facilities.

9. The method of claim 1 further comprises the step of determining and inputting mission critical compliance indicators for the facilities.

10. The method of claim 1 further comprises the step of determining and inputting mission critical engineering operations for the facilities.

11. The method of claim 1 wherein the step of storing the information in the database further comprises storing education information related to the facilities.

12. The method of claim 1 wherein the step of storing the information in the database further comprises storing original equipment manufactures information.

13. The method of claim 1 wherein the step of storing the information in the database further comprises storing customer specific non-facility information.

14. The method of claim 1 wherein the step of providing guaranteed access to the mission critical facilities information includes presenting the information via web pages.

15. The method of claim 1 wherein the step of providing guaranteed access to the mission critical facilities information further comprises storing the data in a plurality of redundant databases.

16. The method of claim 1 wherein the step of providing guaranteed access to the mission critical facilities information includes presenting the information in print form.

17. The method of claim 1 wherein the step providing guaranteed access to the mission critical facilities information includes using search engines to find the information quickly.

18. The method of claim 1 wherein multiple users can access said mission critical facilities information simultaneously.

19. The method of claim 1 further comprising the step of using authentication techniques to restrict the database access to authorized users, and wherein users may have different authorization levels.

20. The method of claim 1 further comprising the step of providing an access log documenting history of users access to said system.

21. A system for organizing and accessing mission critical facilities information relating to facilities comprising:
a) at least one database comprising a plurality of tables listing information relating to mission critical information;
b) at least one data storage device disposed in the at least one server, said data storage device for storing said at least one database;
c) at least one processor disposed in the at least one server, the processor is used for organizing and sorting the mission critical facilities information; and
d) a plurality of web pages stored in the server, said plurality of web pages used for displaying the mission critical facilities information over the computer network.

22. The system as in claim 21, wherein said plurality of web pages further comprise at least one web page for displaying information relating to a security system.

23. The system as in claim 21, wherein said plurality of web pages further comprise at least one web page for displaying information relating to a sprinkler system.

24. The system as in claim 21, wherein said plurality of web pages further comprise at least one web page for displaying information relating to power system.

25. The system as in claim 21, wherein said plurality of web pages further comprise at least one web page for displaying information relating to a fire alarm system.

26. The system as in claim 21, wherein said plurality of web pages further comprise at least one web page for displaying information relating to a heating and ventilating system (HVAC).

27. A computerized interface for directing at least one user to particular mission critical facilities information associated with that user comprising:
a) an Internet connected server; and
b) an interface software executing on said server wherein in response to the at least one user's login, said interface software directs that user to a set of mission critical facilities information relating to that user to display said set of mission critical information relating to said user.

28. The computerized interface of claim 27, further comprising at least one database stored in said Internet connected server, wherein said at least one database includes a plurality of different sets of mission critical facilities information for each of a plurality of buildings and a set of information relating to a set of users enabled to log into said database and wherein said interface software further comprises at least one filter for filtering different sets of mission critical facilities information relating to said at least one user taken from said set of users wherein in response to that user's login, said at least one user is allowed access to only said set of mission critical information relating to said user.

29. The computerized interface as in claim 28, wherein in said at least one database, said different sets of mission critical information for each of said plurality of buildings is divided up into a plurality of different subsets of mission critical facilities information wherein said at least one user is allowed access to only said set and said subset of mission critical facilities information relating to said user.

30. The computerized interface as in claim 29, wherein said plurality of different subsets of mission critical facilities information include information selected from a group consisting of power generation systems, sprinkler systems, fire alarms, electrical systems, security systems, or heating and ventilating systems (HVAC).
